(19) United States
(12) Patent Application Publication
(10) Pub. No.: US 2025/0166165 A1
(43) Pub. Date: May 22, 2025

(54) TRAINING SYSTEMS FOR SURFACE ANOMALY DETECTION

(71) Applicant: Siemens Aktiengesellschaft, Munich (DE)

(72) Inventor: Benjamin Planche, Queens, NY (US)

(73) Assignee: Siemens Aktiengesellschaft, Munich (DE)

(21) Appl. No.: 18/832,529

(22) PCT Filed: Feb. 4, 2022
(86) PCT No.: PCT/US2022/015169

§ 371 Date: Jul. 24, 2024

(51) Int. Cl. G06T 7/00

(52) U.S. Cl. CPC G06T 7/001; G06T 2207/10024; G06T 2207/20081; G06T 2207/20084

(57) ABSTRACT

It is recognized herein that deep-learning approaches to anomaly detection can require a large amount of training data to properly learn the task. It is further recognized herein that capturing images of anomalies can be particularly costly or impractical or, in some cases, impossible. For example, by definition, anomalies can be rare and, therefore, gathering enough samples to train a convolutional neural network can be tedious. Annotating anomalies that are depicted can also be an expensive and time-consuming task. In various examples, realistic synthetic images are generated that include plausible and annotated surface defects (anomalies). Such synthetic images are used to train an efficient anomaly segmentation network in a fully supervised manner.

### BACKGROUND

An anomaly can generally be defined as an event or occurrence that does not follow expected or normal behavior. In the context of neural networks or machine learning, an anomaly can be difficult to define, but the definition can be critical to the success and effectiveness of a given anomaly detector. An efficient anomaly detector should be capable of differentiating between anomalous and normal instances with high precision, so as to avoid false alarms. In some cases, for instance in quality control for manufacturing, detecting anomalies on surfaces of objects is a critical task in computer vision. Current approaches to identifying such surface anomalies often rely on deep-learning architectures to achieve precise detection and/or segmentation of anomalies.

It is recognized herein, however, that deep-learning approaches to anomaly detection can require a large amount of training data to properly learn the task. It is further recognized herein that capturing images of anomalies can be particularly costly or impractical or, in some cases, impossible. For example, by definition, anomalies can be rare and, therefore, gathering enough samples to train a convolutional neural network can be tedious. Annotating anomalies that are depicted can also be an expensive and time-consuming task.

### BRIEF SUMMARY

Embodiments of the invention address and overcome one or more of the described-herein shortcomings by providing methods, systems, and apparatuses that improve anomaly detection. For example, in various embodiments, realistic synthetic images are generated that include plausible and annotated surface defects (anomalies). Further, in accordance with various embodiments, such synthetic images are used to train an efficient anomaly segmentation network in a fully supervised manner.

In an example aspect, an anomaly texture generator can generate first color texture images that include respective surface anomalies. Three-dimensional (3D) models (meshes) of objects associated with the first color texture images are obtained. Based on the 3D models and the first color texture images associated with the 3D models, a rendering module can generate first synthetic images of the respective objects. The first synthetic images can define the objects in a realistic scene. The objects of the first synthetic images can each define a surface and at least one anomaly on the surface of the respective object. An anomaly segmentation network can be trained, to detect anomalies, with the first synthetic images. A real image of a target object can be captured and input into the anomaly segmentation network. The anomaly segmentation network can detect at least one anomaly on a surface of the target object. In some cases, the at least one anomaly defines a stain or unclean portion of the target object. In various examples, the target object is not one of the objects defined by the first synthetic images. The rendering module can further obtain second color texture images associated with the 3D models. In an example, the second color texture images each include no surface anomalies so as to define non-anomalous color texture images. Based on the 3D models and the second color texture images associated with the 3D models, the rendering module can generate second synthetic images of the respective objects. The second synthetic images can define the objects in a realistic scene. The objects of the second synthetic images can each including no surface anomalies so such that the second synthetic images define non-anomalous synthetic images. The anomaly segmentation network can further be trained on the second synthetic images.

### BRIEF DESCRIPTION OF THE SEVERAL VIEWS OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a block diagram of a system that includes a renderer configured to generate synthetic images.

FIG. 2 is a block diagram of another system that includes the renderer configured to generate anomalous synthetic images.

FIG. 3 is a block diagram of a system configured to generate synthetic images to train detection networks to identify surface anomalies, in accordance with example embodiments.

FIG. 4 illustrates a neural network model that can be included in the system shown in FIG. 3, in accordance with an example embodiment.

FIG. 5 is a flow diagram that illustrates operations that the system in FIG. 3 can perform, in accordance with example embodiments.

FIG. 6 illustrates a computing environment within which embodiments of the disclosure may be implemented.

### DETAILED DESCRIPTION

As an initial matter, it is recognized herein that current approaches to anomaly detection or segmentation from images generally rely on weakly supervised or unsupervised training schemes. In particular, for example, image-level annotations that indicate whether a given image contains an anomaly can be leveraged, or normal image distributions can be learned so as to detect deviations. In some computer vision cases, in order to utilize direct supervised training schemes without spending excessive effort collecting real data, synthetic images with annotations can be generated from 3D representations (e.g., CAD models). Further, in some cases, machine learning (ML) based image processing can reduce visual discrepancies between real and synthetic images. In some cases, one or more generative adversarial networks (GANs) can map synthetic images closer to the real domain in an unsupervised manner. It is also recognized herein that some computer graphics approaches purport to render synthetic images with anomalies, but such approaches typically require heavy human parameterization and supervision.

As described herein, various embodiments define a comprehensive pipeline for rendering realistic synthetic images with plausible and annotated surface defects, and for leveraging these synthetic images (or data modalities) to train an efficient anomaly segmentation network in a fully supervised manner. In some examples, anomalies of a given object (which can be referred to as the target object) can be detected with 3D models of the object and few real images of the target object. As used herein, unless otherwise specified, surface anomalies and surface defects can be used interchangeably, without limitation. By way of example, and without limitation, detecting surface anomalies is useful in various manufacturing applications in which a defect might define a change of color or a scratch, but does not change other properties of a given object. For example, in accordance with various embodiments described herein, a system can determine whether medical devices have been properly cleaned or are scratched by inspecting the devices for surface anomalies. It will be understood that various example manufacturing or medical device applications are presented herein to illustrate example embodiments, but embodiments are not limited to the example applications, and all other applications of the embodiments are contemplated as being within the scope of this disclosure.

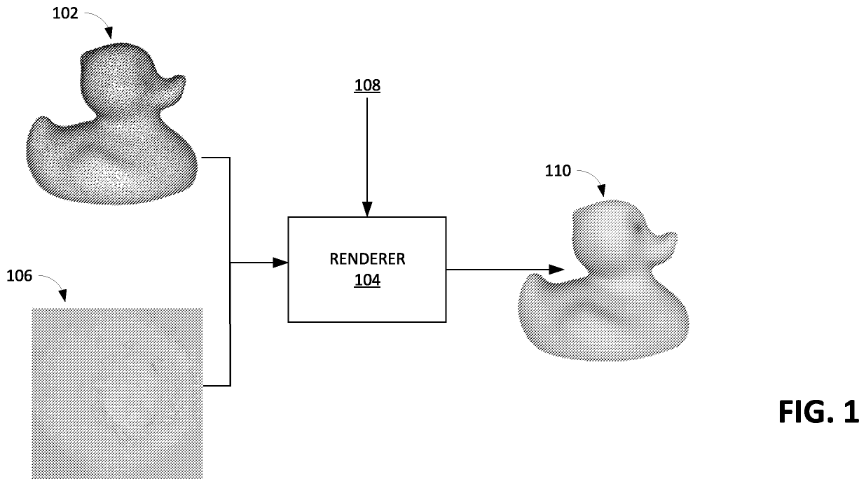

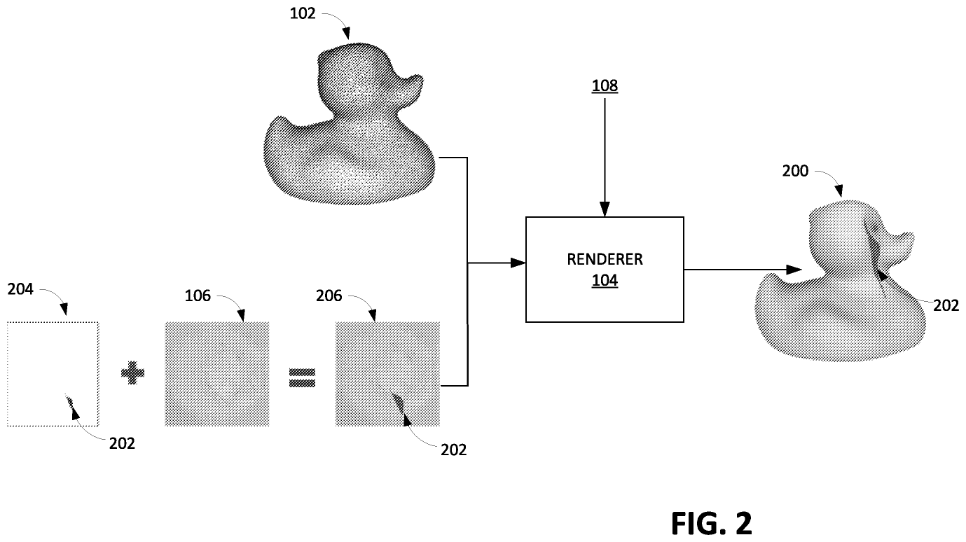

Referring to FIG. 1, objects can be represented by 3D meshes, for instance an example toy object can be represented by an example 3D mesh 102. The mesh 102 can define the 3D surface of the object. A 3D renderer 104 can apply color and texture information 106 of the objects to its mesh 102, and can use rendering parameters 108 associated with the object (e.g., scene properties, camera intrinsics, etc.) so as generate or render a synthetic image 110 of the object. By leveraging various modalities, the 3D renderer 104 can project the 3D mesh 102 into the 2D coordinate system of their virtual camera, and apply shaded colors according to the object's texture information 106 and virtual light settings. Thus, referring also to FIG. 2, it is recognized herein that to render images of an object with anomalies (e.g., anomalous image 200), in particular surface defects, the texture information 106 can be edited so as to include a pixelized anomaly 202 (e.g., a stain) from an anomaly map 204, so as to define an anomalous texture image 206, before the 3D renderer 104 performs the rendering process. It is further recognized herein, however, that manually generating such anomalies may require some artistic effort, in addition to some expert knowledge with respect to which anomalies are realistic for a given object.

To address various technical problems associated with synthetic data generation, in accordance with various embodiments described herein, realistic and varied anomaly texture maps are generated. In some cases, such maps can be generated from few real images of anomalous target objects and normal (non-anomalous) target objects. Further, in various examples, ground-truth segmentation maps are generated that can be used as targets during supervised training of the anomaly detection or segmentation. As used herein, unless otherwise specified, anomaly detection and anomaly segmentation can be used interchangeably without limitation. The ground-truth segmentation maps can define binary images that indicate the location of anomalies in the rendered images.

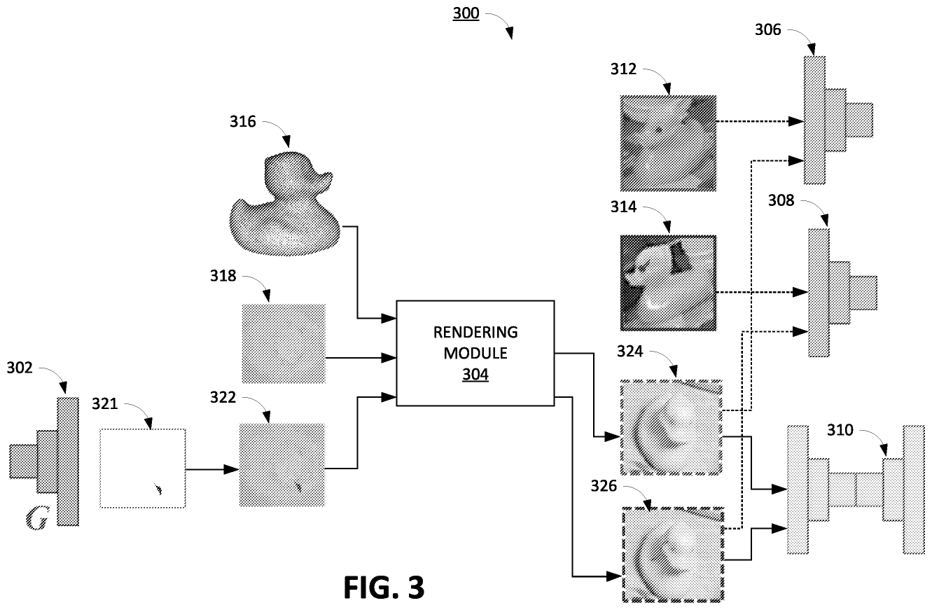

Referring now to FIG. 3, an example computing system 300 can be configured to detect various surface anomalies. The computing system 300 can include one or more processors and memory having stored thereon applications, agents, and computer program modules including, for example, a generative model or anomaly texture generator 302, a rendering module 304 (R), a first discriminator network 306 (D), a second discriminator network 308 (\tilde{D}), and a detection model or anomaly segmentation network 310 (T). It will be appreciated that the program modules, applications, computer-executable instructions, code, or the like depicted in FIG. 3 are merely illustrative and not exhaustive, and that processing described as being supported by any particular module may alternatively be distributed across multiple modules or performed by a different module. In addition, various program module(s), script(s), plug-in(s), Application Programming Interface(s) (API(s)), or any other suitable computer-executable code may be provided to support functionality provided by the program modules, applications, or computer-executable code depicted in FIG. 3 and/or additional or alternate functionality. Further, functionality may be modularized differently such that processing described as being supported collectively by the collection of program modules depicted in FIG. 3 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 3 may be implemented, at least partially, in hardware and/or firmware across any number of devices.

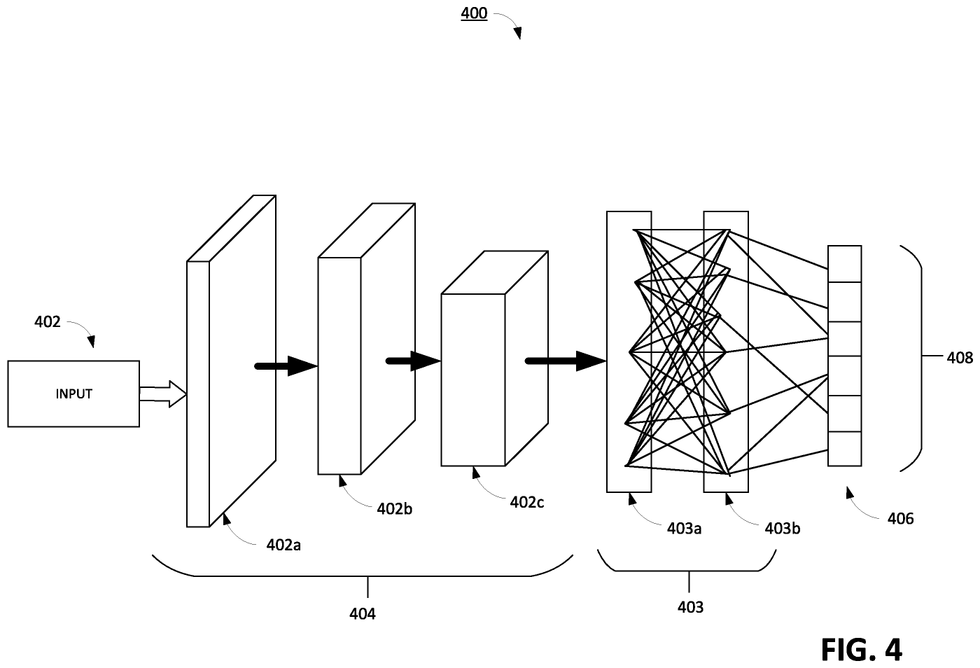

Referring to FIG. 3, in some cases, the anomaly texture generator 302 defines a convolutional neural network (CNN), such as a neural network 400 (see FIG. 4). In particular, the anomaly texture generator 302 can define a generative CNN (G) defined by a set of trainable parameters (θ_{G}). Similarly, the rendering module 304 (R), the first discriminator network 306 (D), the second discriminator network 308 (\tilde{D}), and the anomaly segmentation network 310 (T), can respectively include one or more neural networks, such as the network 400. The networks can be trained using various data modalities. For example, the networks can be trained using real images 312 (xᵣ) of one or more given target objects that do not include a surface anomaly. In particular, the networks can be trained on a small set of such non-anomalous real images 312, which can be represented by Xᵣ={x_{r,i}}ᵢ₌₀ⁿ. The networks can further be trained on real images 314 (\tilde{x}ᵣ) of one or more given target objects that each include at least one surface anomaly. In particular, the networks can be trained on a small set of such anomalous real images 314, which can be represented by \tilde{X}ᵣ={\tilde{x}_{r,i}}ᵢ₌₀^{ñ}. The data modalities that are available and used for training can further include models or 3D meshes 316 (S) that represent the 3D surface of one or more given target objects. Additionally, or alternatively, the networks can be trained on color texture images 318 (t) of one or more target objects. The texture images 318 can define a size, for instance a height and width, which can be represented by h×w. A given texture image 318 can be represented by t∈ [symbol] ^{h×w×3}. In various examples, the texture images 318 (t) define a respective original texture image. In particular, by way of example and without limitation, the texture image 318 can define a texture of yellow and black shades which, when properly sampled and applied to the corresponding 3D model (e.g., 3D model 316), can result in a model that represents a yellow rubber duck.

With continuing reference to FIG. 3, the anomaly texture generator 302 can be represented as G(z; θ_{G})=δt, where z represents a noise vector (z˜ [symbol] (0,1)) that the anomaly texture generator 302 (G) can receive as input, and at can represent a defect/stain or anomalous image or map 321. In some cases, the anomaly texture generator 302 defines a learnable machine-learning model. In particular, by way of example and without limitation, the anomalous image 321 can define a transparent image having one or more spots which, when properly sampled and applied to the corresponding 3D model (e.g., 3D model 316), can result in a model that includes a realistic anomaly (e.g., defect or stain). The noise vector can be sampled from a normal distribution so as to return or generate the anomaly map 321 that can be represented as at δt∈ [symbol] ^{h×w×3}. Using the color texture image 318 and the anomaly map 321, an anomaly texture map 322 (or texture map that contains an anomaly) can be generated, which can be represented as \tilde{t}=t+δt. Thus, as \tilde{t}=t+δt can represent a texture image with an anomaly added to the texture image, or the anomaly texture map 322. In particular, by way of example and without limitation, the anomaly texture map 322 can define an image that can be sampled and applied to its corresponding 3D model (e.g., model 316) so as to result in a model that maintains its original appearance except for at least one real-looking anomaly that is added to the model.

With continuing reference to FIG. 3, the system 300 can pass the 3D meshes 316 (S) and the color texture images 318 (t) to the rendering module 304 (R), so as to obtain synthetic images 324 that do not include anomalies. The rendering module 304 can generate the synthetic images 324 by varying camera poses, scene parameters, and the like. In some cases, the rendering module 304 can perform differentiable rendering using differentiable equations. In particular, for example, the rendering module 304 can perform various computer-graphics rendering (e.g., ray-casting, rasterization, perspective projection, etc.) using differentiable operations. In various embodiments, the rendering module 304 performs differentiable rendering so as to propagate training losses computed over the rendered images, and corresponding gradients, back to the generative model (G) (anomaly texture generator 302). In particular, the anomaly texture generator 302 can be trained based on feedback that indicates how realistic the previously generated anomalous image 326, how the weights of the neural network can be updated to generate more realistic anomalous images 326, or the like. In an example, the realism (or lack thereof) of the generated anomalies can be determined or appreciated when applied to the 3D model to create 2D images. Thus, the rendering module 304 can back-propagate the gradients through its 3D rendering process, such that the gradients can be used as generative components within larger 2D or 3D deep-learning systems. To propagate the feedback back to the anomaly texture generator 302, in various examples, the operations between the generative model 302 and the loss are differentiable, such that the associated gradients can be computed and propagated. Thus, in accordance with various embodiments, because the rendering module 304 defines an operation between the generative model and the loss(es), the rendering performed by the rendering module 304 is differentiable. Further, the loss, for instance the scalar value from one or more differentiable metrics that quantify the error of the machine learning model, can be computed over the rendered images, so as to measure the realism of those images.

Thus, the rendering module 304 can define a differentiable rendering module R that is defined as a function that is parametrized by parameters θ_{R}. The differential rendering function can be represented as R(S, t; θ_{R}) {xₛ,yₛ}, wherein xₛ represents non-anomalous synthetic images 324, and yₛ represents an anomaly semantic map that corresponds to a particular synthetic image xₛ. In various examples, yₛ is empty when xₛ defines a non-anomalous synthetic image 324. Additionally, the rendering function can be represented as R(S, \tilde{t}; θ_{R})={ [symbol] , [symbol] }, wherein [symbol] represents anomalous synthetic images 326, and [symbol] represents an anomaly semantic map that corresponds to a particular synthetic image [symbol] . The anomalous synthetic images 326 include one or more surface anomalies. The parameters θ_{R} can define various attributes associated with a given scene, such intrinsic properties of a virtual camera, scene clutter, lighting conditions, or the like, such that the rendering module 304 can learn to render synthetic images defining optimal or realistic visual scenes. In particular, the rendering module 304 can optimize the parameters θ_{R} to optimize visual scenes, so as to render realistic synthetic images from 3D models and texture images.

In various examples, the system 300 performs adversarial training to teach the anomaly texture generator 302 to generate realistic anomalous texture images 322, and to teach the rendering module 304 to render more realistic synthetic images 324 and 326, based on the corresponding 3D model 316 that is received by the rendering module 304. In particular, by way of example, as the rendering module 304 is trained, the rendering module 304 can learn more realistic clutter and lighting settings, so as to generate more realistic synthetic images 324 and 326. In the architecture defined by the computing system 300, the anomaly texture generator 302 and the rendering module 304 can define the generative network of the architecture, and the first discriminator network 306 (D) and the second discriminator network 308 (\tilde{D}) can define the discriminative network of the architecture that determines whether images are real or synthetic. In particular, for example, the first discriminator network 306 (D(x; θ_{D})) can be tasked to distinguish between non-anomalous synthetic images 324 and non-anomalous real images 312, as to determine whether the non-anomalous images are real or synthetic. Similarly, the second discriminator network 308 (\tilde{D}(x; θ_{\tilde{D}})) can be tasked to distinguish between anomalous synthetic images 326 and anomalous real images 314, so as to determine whether images having at least one surface anomaly are real or synthetic. The above-mentioned networks of the system 300 can trained using typical generative adversarial network (GAN) losses, such as cross-entropy over the discriminators' predictions. For example, losses computed by the discriminative network, in particular the first discriminator network 306 and the second discriminator network 308, can be returned to the rendering module 304 to train the rendering module 304.

In particular, the discriminator networks 306 and 308 can be trained as classifiers that determine whether an image is fake or real. Given an input image, the discriminator networks can predict if that image is real (actual picture) or fake (synthetic image). Their loss function can correspond to the inaccuracy of their predictions over training images (e.g., computed as cross-entropy). Generative models, for instance the anomaly texture generator 302 or the rendering module 304, can be trained to fool discriminator networks, for instance the first and second discriminator networks 306 and 308. In particular, for example, an object these generative models can be to generate an output (synthetic images) that is classified as real (real images) by the discriminator networks, which can be referred to as a min-max strategy between generators and discriminators. Thus, their loss functions can correspond to the accuracy of a given discriminator's predictions over the generated images.

Still referring to FIG. 3, the anomaly segmentation network 310 (T) can receive an image (x) and return or generate a probability map (m) corresponding to the image. The anomaly segmentation network 310 can be represented as T(x; θ_{T})=y, wherein parameters θ_{R} are optimized during training to segment or detect real anomalies. In particular, the probability map can indicate the presence of anomalies within the corresponding image. In an example, the anomaly segmentation network 310 can be trained independently over synthetic images 324 and 326 (which can be represented by synthetic datasets {x_{s,i}, y_{s,i}}ᵢ₌₀ⁿ^{ₛ} and { [symbol] , [symbol] respectively) that are rendered after the optimization of the anomaly texture generator 302 and the rendering module 304. Alternatively, in some cases, the anomaly segmentation network 310 is trained with the other networks (e.g., anomaly texture generator 302 and rendering module 304) are trained so as to make the anomaly segmentation network 310 more robust to data variability. In particular, the anomaly segmentation network 310 can be trained over each batch of synthetic images 324 and 326, so as to leverage traditional supervised losses, for example, by comparing the predicted output (y) of the anomaly detection model (e.g., anomaly segmentation network 310) to the corresponding ground-truth map. The output of the anomaly detection models (y) can define a probability/semantic map that can be binarized into a mask highlighting where the anomaly is in the image. The ground-truth maps can be manually annotated by experts in the case of real images, or automatically generated, for example, for synthetic images in which the position of the simulated anomaly in the image is known. In various example embodiments, the ground-truth anomaly mask can be obtained by rendering the 3D model a second time (for each training image) using the same parameters except using δt instead of \tilde{t} for the texture.

Additionally, or alternatively, the anomaly segmentation network 310 can be trained over real non-anomalous images 312 (xᵣ), using empty semantic maps as target ground-truth. In various examples, the error from the anomaly segmentation network 310 is back-propagated to the anomaly texture generator 302 to further train the anomaly texture generator 302 to generate anomalies that are realistic and challenging for the anomaly segmentation network 310 to detect, for example, because of increases to loss and error. By way of example, to create realistic anomaly images, the generative models can be pit against the discriminators in a min-max game, such that the discriminator learns to distinguish between real and fake images, while the generator learns to generate more-and-more realistic images to fool the other model. In an example in which the goal is to train a third model to detect actual anomalies in real images, synthetic anomaly images can be created that are not only realistic, but also challenging for the anomaly detection model. It is recognized herein that, in some cases, the more challenging its training, the more likely the detection model will perform well in real conditions. Thus, the detection model can learn to detect an anomaly, while the generator can learn to generate challenging anomalies. In particular, the generator models can generate challenging and realistic anomalies because the generator is still competing against the discriminators, in parallel.

Thus, as described above, the computing system 300 can automatically learn to render realistic images of surface anomalies in an unsupervised manner. Such images can define precious annotated training data for various anomaly detection/segmentation networks or systems. For example, by rendering such synthetic data, the anomaly segmentation network 310 can be trained using the synthetic data, such that the anomaly segmentation network 310 can detect more anomalies more accurately as compared to anomaly segmentation networks that do not have access to the synthetic data described herein.

Referring to FIG. 4, the computing system 300, in particular the anomaly segmentation network 310, the anomaly texture generator 302, the rendering module 304, and the first and second discriminator networks 306 and 308, can define one or more systems or networks 100 that can be trained on a plurality of input images 402. The input images 402 can define respective scenes, for instance industrial scenes that include one or more machines or components, or medical scenes that include medical devices or bodily structures. It will be understood that that the input images are not limited to the examples described herein. That is, the input images 402 can vary as desired, and all such input images are contemplated as being within the scope of this disclosure. Further, in various examples, the input images 402 can define a vectorized input, RGB images, CAD images, or the like. The input images 402 can include anomalous and non-anomalous synthetic images 324 and 326, respectively, or real images that are captured by various sensors or camera, and all such images are contemplated as being within the scope of this disclosure. By way of example, a given input image 402 of a given machine can be captured by a camera positioned to capture images of all or part of the machine. As described further herein, in accordance with various embodiments, the system 400 can be trained on input images 402 that are non-anomalous or anomalous. Generally non-anomalous images are images that define a scene that is ordinary, or is consistent with an expectation for the scene. By way of example, a non-anomalous image of a particular device, such as a medical tool, might depict the device in its normal operating state that is consistent with its design. Continuing with the example, an anomalous image of the same device might depict a tool that is stained or otherwise uncleaned, or includes a damaged component.

With continuing reference to FIG. 4, the network 400 can define an adversarial variational autoencoder (AVAE) system, for instance a convolutional AVAE. The example neural network 400 includes a plurality of layers, for instance an input layer 402a configured to receive images, an output layer 403b configured to generate class or output scores associated with the images or portions of the image. For example, the output layer 403b can be configured to determine whether an image is real or synthetic, or whether an image is anomalous or non-anomalous. The neural network 400 further includes a plurality of intermediate layers connected between the input layer 402a and the output layer 403b. In particular, in some cases, the intermediate layers and the input layer 402a can define a plurality of convolutional layers 402. The intermediate layers can further include one or more fully connected layers 403. The convolutional layers 402 can include the input layer 402a configured to receive training and test data, such as images. In some cases, training data that the input layer 402a receives includes synthetic data of arbitrary objects. Synthetic data can refer to training data that has been generated by rendering module 304, as described herein. The convolutional layers 402 can further include a final convolutional or last feature layer 402c, and one or more intermediate or second convolutional layers 402b disposed between the input layer 402a and the final convolutional layer 402c. It will be understood that the illustrated model 400 is simplified for purposes of example. In particular, for example, models may include any number of layers as desired, in particular any number of intermediate layers, and all such models are contemplated as being within the scope of this disclosure.

The fully connected layers 403, which can include a first layer 403a and a second or output layer 403b, include connections between layers that are fully connected. For example, a neuron in the first layer 403a may communicate its output to every neuron in the second layer 403b, such that each neuron in the second layer 403b will receive input from every neuron in the first layer 403a. It will again be understood that the model is simplified for purposes of explanation, and that the model 400 is not limited to the number of illustrated fully connected layers 403. In contrast to the fully connected layers, the convolutional layers 402 may be locally connected, such that, for example, the neurons in the intermediate layer 402b might be connected to a limited number of neurons in the final convolutional layer 402c. The convolutional layers 402 can also be configured to share connections strengths associated with the strength of each neuron.

Still referring to FIG. 4, the input layer 402a can be configured to receive inputs 404, for instance an image 404, and the output layer 403b can be configured to return an output 406. The output 406 can include one or more classifications or scores associated with the input 404. For example, the output 406 can include an output vector that indicates a plurality of scores 408 associated with various portions, for instance pixels, of the corresponding input 404. Thus, the output layer 403b can be configured to generate scores 408 associated with the image 404, in particular associated with pixels of the image 404, thereby generating anomaly scores associated with locations of the object depicted in the image 404.

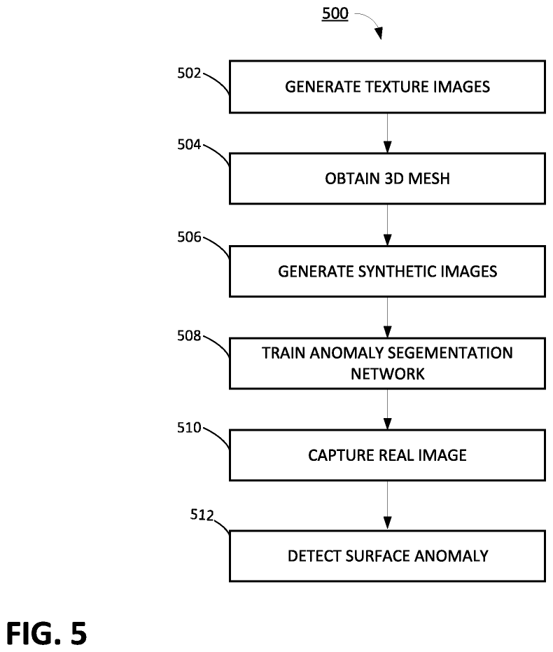

Referring now to FIG. 5, example operations 300 are shown that can be performed by the system 300, which can include one or more neural networks 400. At 502, the anomaly texture generator 302 can generate first color texture images that include respective surface anomalies. At 504, 3D models (meshes) of objects associated with the first color texture images are obtained. At 506, based on the 3D models and the first color texture images associated with the 3D models, the rendering module 304 can generate first synthetic images of the respective objects. The first synthetic images can define the objects in a realistic scene. The objects of the first synthetic images can each define a surface and at least one anomaly on the surface of the respective object. At 508, the anomaly segmentation network 310 can be trained, to detect anomalies, with the first synthetic images. At 510, a real image of a target object can be captured and input into the anomaly segmentation network 310. At 512, the anomaly segmentation network 310 can detect at least one anomaly on a surface of the target object. In some cases, the at least one anomaly defines a stain or unclean portion of the target object. In various examples, the target object is not one of the objects defined by the first synthetic images. The rendering module 304 can further obtain second color texture images associated with the 3D models. In an example, the second color texture images includes no surface anomalies so as to define non-anomalous color texture images. Based on the 3D models and the second color texture images associated with the 3D models, the rendering module 304 can generate second synthetic images of the respective objects. The second synthetic images cam define the objects in a realistic scene. The objects of the second synthetic images can each including no surface anomalies so such that the second synthetic images define non-anomalous synthetic images. At 508, the anomaly segmentation network can further be trained on the second synthetic images.

In various examples, the first discriminator network 306 obtains real images of objects. The first discriminator network 306 is trained on the real images of objects and the second synthetic images. The first discriminator network 306 can generate predictions and losses associated with the respective predictions. The predictions can indicate whether images are real or synthetic. The system 300 can backpropagate the losses to the rendering module 304 so as to optimize the rendering module 304. Similarly, the second discriminator network 308 can obtain real images of objects that each define at least one surface anomaly. In an example, the second discriminator network 308 is trained on the real images of objects that each define at least one surface anomaly and the first synthetic images. The second discriminator network 308 can generate predictions and losses associated with the respective predictions, wherein the predictions indicate whether images are real or synthetic. The system 300 can backpropagate the losses to the rendering module 304 so as to optimize the rendering module 304. In various examples, the anomaly segmentation network 310, the first discriminator network 306, the second discriminator network 308, and the rendering module 304 are trained in parallel with one another so as to be trained at the same time.

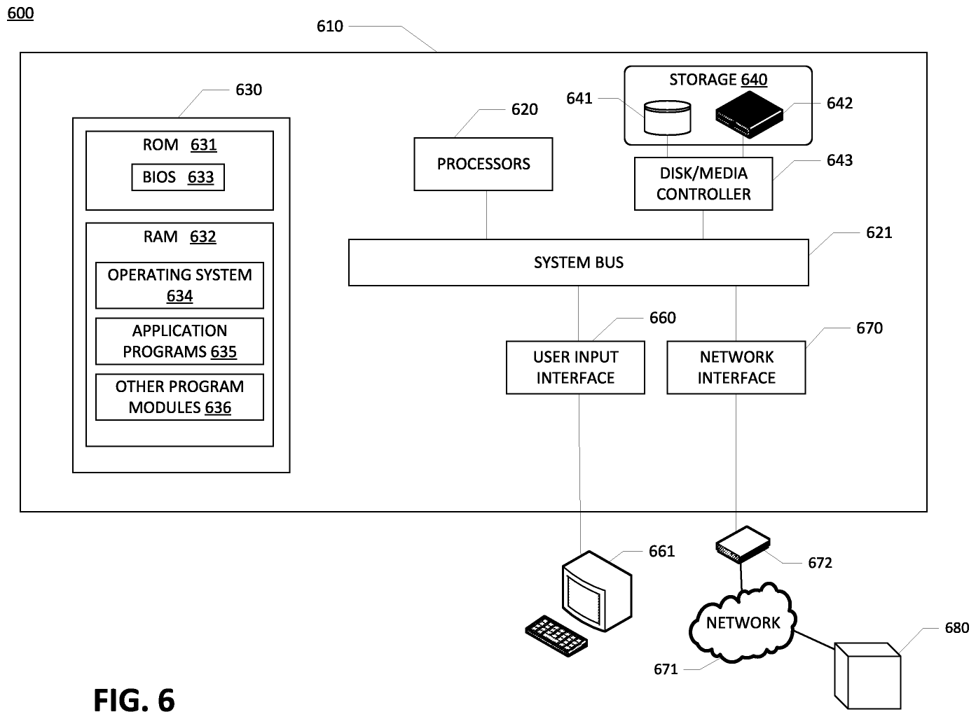

FIG. 6 illustrates an example of a computing environment within which embodiments of the present disclosure may be implemented. A computing environment 600 includes a computer system 610 that may include a communication mechanism such as a system bus 621 or other communication mechanism for communicating information within the computer system 610. The computer system 610 further includes one or more processors 620 coupled with the system bus 621 for processing the information. The system 300 may include, or be coupled to, the one or more processors 620.

The processors 620 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 620 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 621 may include at least one of a system bus, a memory bus, an address bus, or a message bus, and may permit exchange of information (e.g., data (including computer-executable code), signaling, etc.) between various components of the computer system 610. The system bus 621 may include, without limitation, a memory bus or a memory controller, a peripheral bus, an accelerated graphics port, and so forth. The system bus 621 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 6, the computer system 610 may also include a system memory 630 coupled to the system bus 621 for storing information and instructions to be executed by processors 620. The system memory 630 may include computer readable storage media in the form of volatile and/or nonvolatile memory, such as read only memory (ROM) 631 and/or random access memory (RAM) 632. The RAM 632 may include other dynamic storage device(s) (e.g., dynamic RAM, static RAM, and synchronous DRAM). The ROM 631 may include other static storage device(s) (e.g., programmable ROM, erasable PROM, and electrically erasable PROM). In addition, the system memory 630 may be used for storing temporary variables or other intermediate information during the execution of instructions by the processors 620. A basic input/output system 633 (BIOS) containing the basic routines that help to transfer information between elements within computer system 610, such as during start-up, may be stored in the ROM 631. RAM 632 may contain data and/or program modules that are immediately accessible to and/or presently being operated on by the processors 620. System memory 630 may additionally include, for example, operating system 634, application programs 635, and other program modules 636. Application programs 635 may also include a user portal for development of the application program, allowing input parameters to be entered and modified as necessary.

The operating system 634 may be loaded into the memory 630 and may provide an interface between other application software executing on the computer system 610 and hardware resources of the computer system 610. More specifically, the operating system 634 may include a set of computer-executable instructions for managing hardware resources of the computer system 610 and for providing common services to other application programs (e.g., managing memory allocation among various application programs). In certain example embodiments, the operating system 634 may control execution of one or more of the program modules depicted as being stored in the data storage 640. The operating system 634 may include any operating system now known or which may be developed in the future including, but not limited to, any server operating system, any mainframe operating system, or any other proprietary or non-proprietary operating system.

The computer system 610 may also include a disk/media controller 643 coupled to the system bus 621 to control one or more storage devices for storing information and instructions, such as a magnetic hard disk 641 and/or a removable media drive 642 (e.g., floppy disk drive, compact disc drive, tape drive, flash drive, and/or solid state drive). Storage devices 640 may be added to the computer system 610 using an appropriate device interface (e.g., a small computer system interface (SCSI), integrated device electronics (IDE), Universal Serial Bus (USB), or FireWire). Storage devices 641, 642 may be external to the computer system 610.

The computer system 610 may also include a field device interface 665 coupled to the system bus 621 to control a field device 666, such as a device used in a production line. The computer system 610 may include a user input interface or GUI 661, which may comprise one or more input devices, such as a keyboard, touchscreen, tablet and/or a pointing device, for interacting with a computer user and providing information to the processors 620.

The computer system 610 may perform a portion or all of the processing steps of embodiments of the invention in response to the processors 620 executing one or more sequences of one or more instructions contained in a memory, such as the system memory 630. Such instructions may be read into the system memory 630 from another computer readable medium of storage 640, such as the magnetic hard disk 641 or the removable media drive 642. The magnetic hard disk 641 and/or removable media drive 642 may contain one or more data stores and data files used by embodiments of the present disclosure. The data store 640 may include, but are not limited to, databases (e.g., relational, object-oriented, etc.), file systems, flat files, distributed data stores in which data is stored on more than one node of a computer network, peer-to-peer network data stores, or the like. The data stores may store various types of data such as, for example, skill data, sensor data, or any other data generated in accordance with the embodiments of the disclosure. Data store contents and data files may be encrypted to improve security. The processors 620 may also be employed in a multi-processing arrangement to execute the one or more sequences of instructions contained in system memory 630. In alternative embodiments, hard-wired circuitry may be used in place of or in combination with software instructions. Thus, embodiments are not limited to any specific combination of hardware circuitry and software.

As stated above, the computer system 610 may include at least one computer readable medium or memory for holding instructions programmed according to embodiments of the invention and for containing data structures, tables, records, or other data described herein. The term “computer readable medium” as used herein refers to any medium that participates in providing instructions to the processors 620 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 641 or removable media drive 642. Non-limiting examples of volatile media include dynamic memory, such as system memory 630. Non-limiting examples of transmission media include coaxial cables, copper wire, and fiber optics, including the wires that make up the system bus 621. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 400 may further include the computer system 610 operating in a networked environment using logical connections to one or more remote computers, such as remote computing device 680. The network interface 670 may enable communication, for example, with other remote devices 680 or systems and/or the storage devices 641, 642 via the network 671. Remote computing device 680 may be a personal computer (laptop or desktop), a mobile device, a server, a router, a network PC, a peer device or other common network node, and typically includes many or all of the elements described above relative to computer system 610. When used in a networking environment, computer system 610 may include modem 672 for establishing communications over a network 671, such as the Internet. Modem 672 may be connected to system bus 621 via user network interface 670, or via another appropriate mechanism.

Network 671 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 610 and other computers (e.g., remote computing device 680). The network 671 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 671.

It should be appreciated that the program modules, applications, computer-executable instructions, code, or the like depicted in FIG. 6 as being stored in the system memory 630 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 610, the remote device 680, and/or hosted on other computing device(s) accessible via one or more of the network(s) 671, may be provided to support functionality provided by the program modules, applications, or computer-executable code depicted in FIG. 6 and/or additional or alternate functionality. Further, functionality may be modularized differently such that processing described as being supported collectively by the collection of program modules depicted in FIG. 3 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 6 may be implemented, at least partially, in hardware and/or firmware across any number of devices.

It should further be appreciated that the computer system 610 may include alternate and/or additional hardware, software, or firmware components beyond those described or depicted without departing from the scope of the disclosure. More particularly, it should be appreciated that software, firmware, or hardware components depicted as forming part of the computer system 610 are merely illustrative and that some components may not be present or additional components may be provided in various embodiments. While various illustrative program modules have been depicted and described as software modules stored in system memory 630, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
generating, by an anomaly texture generator, first color texture images that include respective surface anomalies;
obtaining 3D models of objects associated with the first color texture images;
based on the 3D models and the first color texture images associated with the 3D models, a rendering module generating first synthetic images of the respective objects, the first synthetic images defining the objects in a realistic scene, the objects of the first synthetic images each defining a surface and at least one anomaly on the surface of the respective object; and
training an anomaly segmentation network, to detect anomalies, with the first synthetic images.

2. The method as recited in claim 1, the method further comprising:
capturing a real image of a target object;
inputting the real image of the target object into the anomaly segmentation network;
detecting, by the anomaly segmentation network, at least one anomaly on a surface of the target object.

3. The method as recited in claim 2, wherein the at least one anomaly defines a stain or unclean portion of the target object.

4. The method as recited in claim 2, wherein the target object is not one of the objects defined by the first synthetic images.

5. The method as recited in claim 1, the method further comprising:
obtaining, by the rendering module, second color texture images associated with the 3D models, the second color texture images including no surface anomalies so as to define non-anomalous color texture images; and
based on the 3D models and the second color texture images associated with the 3D models, the rendering module generating second synthetic images of the respective objects, the second synthetic images defining the objects in a realistic scene, the objects of the second synthetic images each including no surface anomalies so such that the second synthetic images define non-anomalous synthetic images.

6. The method as recited in claim 5, the method further comprising:
obtaining, by a first discriminator network, real images of objects;
training the first discriminator network on the real images of objects and the second synthetic images;
generating, by the first discriminator network, predictions and losses associated with the respective predictions, the predictions indicating whether images are real or synthetic; and
backpropagating the losses to the rendering module so as to optimize the rendering module.

7. The method as recited in claim 5, the method further comprising:
obtaining, by a second discriminator network, real images of objects that each define at least one surface anomaly;
training the second discriminator network on the real images of objects that each define at least one surface anomaly and the first synthetic images;
generating, by the second discriminator network, predictions and losses associated with the respective predictions, the predictions indicating whether images are real or synthetic; and
backpropagating the losses to the rendering module so as to optimize the rendering module.

8. The method as recited in claim 7, the method further comprising:
training the anomaly segmentation network, the first discriminator network, the second discriminator network, and the rendering module in parallel with one another.

9. A system comprising a rendering module, an anomaly texture generator, and an anomaly segmentation network the system further comprising:
a processor; and
a memory storing instructions that, when executed by the processor, configure the system to:
generate, by the anomaly texture generator, first color texture images that include respective surface anomalies;
obtain 3D models of objects associated with the first color texture images;
based on the 3D models and the first color texture images associated with the 3D models, generate, by the rendering module, first synthetic images of the respective objects, the first synthetic images defining the objects in a realistic scene, the objects of the first synthetic images each defining a surface and at least one anomaly on the surface of the respective object; and
training the anomaly segmentation network, to detect anomalies, with the first synthetic images.

10. The system as recited in claim 9, the memory further storing instructions that, when executed by the processor, further configure the system to:
capture a real image of a target object;
input the real image of the target object into the anomaly segmentation network;
detect, by the anomaly segmentation network, at least one anomaly on a surface of the target object.

11. The system as recited in claim 10, wherein the at least one anomaly defines a stain or unclean portion of the target object.

12. The system as recited in claim 10, wherein the target object is not one of the objects defined by the first synthetic images.

13. The system as recited in claim 9, the memory further storing instructions that, when executed by the processor, further configure the system to:
obtain, by the rendering module, second color texture images associated with the 3D models, the second color texture images including no surface anomalies so as to define non-anomalous color texture images; and
based on the 3D models and the second color texture images associated with the 3D models, generate, by the rendering module, second synthetic images of the respective objects, the second synthetic images defining the objects in a realistic scene, the objects of the second synthetic images each including no surface anomalies so such that the second synthetic images define non-anomalous synthetic images.

14. The system as recited in claim 13, the system further comprising a first discriminator network, the memory further storing instructions that, when executed by the processor, further configure the system to:
obtain, by the first discriminator network, real images of objects;
train the first discriminator network on the real images of objects and the second synthetic images;
generate, by the first discriminator network, predictions and losses associated with the respective predictions, the predictions indicating whether images are real or synthetic; and
backpropagate the losses to the rendering module so as to optimize the rendering module.

15. The system as recited in claim 13, the system further comprising a second discriminator network, the memory further storing instructions that, when executed by the processor, further configure the system to:
obtain, by the second discriminator network, real images of objects that each define at least one surface anomaly;
train the second discriminator network on the real images of objects that each define at least one surface anomaly and the first synthetic images;
generate, by the second discriminator network, predictions and losses associated with the respective predictions, the predictions indicating whether images are real or synthetic; and
backpropagate the losses to the rendering module so as to optimize the rendering module.
